(19) United States
(12) Patent Application Publication
(10) Pub. No.: US 2020/0019043 A1
(43) Pub. Date: Jan. 16, 2020

(54) MAGNETIC LENS FILTER SYSTEM

(71) Applicant: David Graham Clark, Lakewood, CO (US)

(72) Inventor: David Graham Clark, Lakewood, CO (US)

(21) Appl. No.: 16/553,036

(22) Filed: Aug. 27, 2019

Related U.S. Application Data
(63) Continuation-in-part of application No. 16/034,662, filed on Jul. 13, 2018.

(51) Int. Cl. G03B 17/14; G03B 11/00; G02B 7/00

(52) U.S. Cl. CPC G03B 17/14; G02B 7/006; G03B 11/00

(57) ABSTRACT

A magnetic lens filter system includes an external rotational element having a plurality of ridges allowing a photographer to grip and rotate the external rotational element. A plurality gears extend the rotation from the external rotating element to an interface member. One or more magnetic lens filters are configured to magnetically engage with the interface member, enabling the magnetic lens filter system to rotate the one or more attached magnetic lens filters. The magnetic lens filter system is configured to attach to a rectangular filter hold enabling the addition of rectangular filters. The one or more magnetic lens filters are stackable.

### CROSS-REFERENCE TO RELATED APPLICATIONS

The present invention is a continuation in part application to U.S. patent application Ser. No. 16/034,662 entitled “Magnetic lens filter system” filed Jul. 13, 2018, which is hereby incorporated in its entirety at least by reference.

### BACKGROUND OF THE INVENTION

### 1. Field of the Invention

The present invention relates to camera filters, and more specifically a magnetic lens filter system.

### 2. Description of Related Art

In the art of camera lens filters, also called lens filters or photography filters, there has been very limited advancement in the field. In advanced photography practices, photography filters are useful for a variety of reasons. In addition to providing a protective lens for a camera lens, photography filters modify the images captured with a camera, including enhancing color, reducing reflections, or aiding in capturing scenery in extremely difficult lighting conditions.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a magnetic lens filter system is provided, comprising: a primary structural member including an attachment ring and a flange; an external rotational element having a plurality of ridges, the external rotational element attached to the primary structural member; a plurality of gears positioned in a plurality of gear positioning structures provided in the primary structural member, wherein the plurality of gears is in engagement with the external rotational element; an interface member configured to engage an inner gear in engagement with the plurality of gears such that when the external rotational element is rotated the inner interface member rotates, wherein the inner rotational element is positioned inside the primary structural member; and, a removable magnetic lens filter configured to magnetically engage with the interface member such that the removable lens filter rotates when the external rotational element rotates.

In one embodiment, the attachment ring is threaded and configured to attach to a front portion of a camera. In another embodiment, the system is configured to attach to a rectangular filter holder, wherein the rectangular filter holder is configured to hold a plurality of rectangular filters. In one embodiment, the plurality of ridges is equally spaced and extends on an entire circumference of the external rotational element. In one embodiment, the removable magnetic lens filter is configured to be removed from interface member via pressure without rotation. In one embodiment, the external rotational element includes a protrusion configured to engage with a groove positioned on the primary structural member. In another embodiment, the removable magnetic lens filter comprises a magnetic lens holder containing magnets, wherein additional removable magnetic lens filters are configured to stack to the removable magnetic lens filter. In yet another embodiment, the rectangular filter holder comprises an engagement tab and lock mechanism, wherein the lock mechanism is configured to engage the flange of the primary structural member to secure the magnetic lens filter system in the rectangular filter holder. In one embodiment, the lock mechanism is released via pressure applied to the engagement tab by a user.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a front perspective view of a magnetic lens filter system according to an embodiment of the present invention;

FIG. 2 is a top view of the magnetic lens filter system according to an embodiment of the present invention;

FIG. 3A is a side exploded view of the magnetic lens filter system with the lens filter removed according to an embodiment of the present invention;

FIG. 3B is a detailed view of the primary structural member of FIG. 3A;

FIG. 3C is a detailed view of the magnetic filter inner rotational element of FIG. 3A;

FIGS. 4A-B are front and rear perspective views of the external rotational element according to an embodiment of the present invention;

FIG. 4C is a detail of C of FIG. 4A;

FIG. 5A is a side view of the magnetic lens filter system according to an embodiment of the present invention;

FIG. 5B is a sectional view taken along section 5B-5B of FIG. 5A;

FIG. 5C is detail of C of FIG. 5B;

FIG. 6 is a side exploded view of the magnetic lens filter system with a lens filter according to an embodiment of the present invention;

FIG. 7 is a perspective view of an adapter according to an embodiment of the present invention;

FIG. 8A is a side view of the adapter according to an embodiment of the present invention;

FIG. 8B is a sectional view taken along section 8B-8B of FIG. 8A;

FIG. 9A is a perspective view of a magnetic lens filter according to an embodiment of the present invention;

FIG. 9B is a side view of the magnetic lens filter according to an embodiment of the present invention;

FIG. 10 is a rear perspective view of the magnetic lens filter system attached to a rectangular filter holder according to an embodiment of the present invention;

FIG. 11 is a perspective view of the magnetic lens filter system attached to the rectangular filter holder according to an embodiment of the present invention;

FIG. 12 is a top view of the magnetic lens filter system attached to the rectangular filter holder according to an embodiment of the present invention;

FIG. 13A is a side view of the magnetic lens filter system prior to being attached to the rectangular filter holder according to an embodiment of the present invention;

FIG. 13B is a side view of the magnetic lens filter system attached to the rectangular filter holder according to an embodiment of the present invention;

FIG. 14 is a perspective view of the magnetic lens filter system with stackable magnetic lens filters according to an embodiment of the present invention; and,

FIG. 15 is an exploded perspective view of the magnetic lens filter system with stackable magnetic lens filters according to an embodiment of the present invention

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a magnetic lens filter system 100.

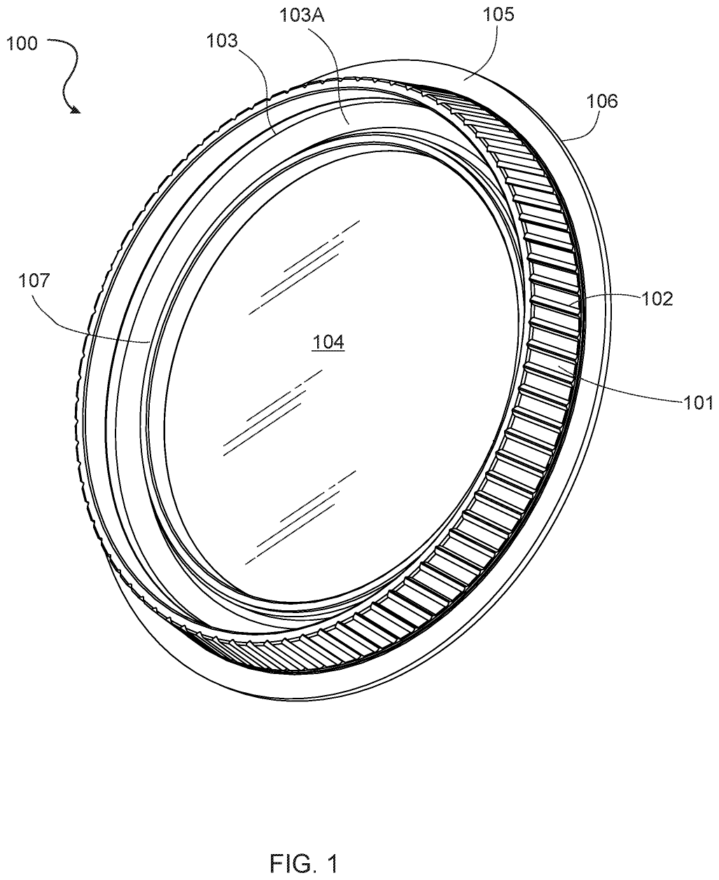

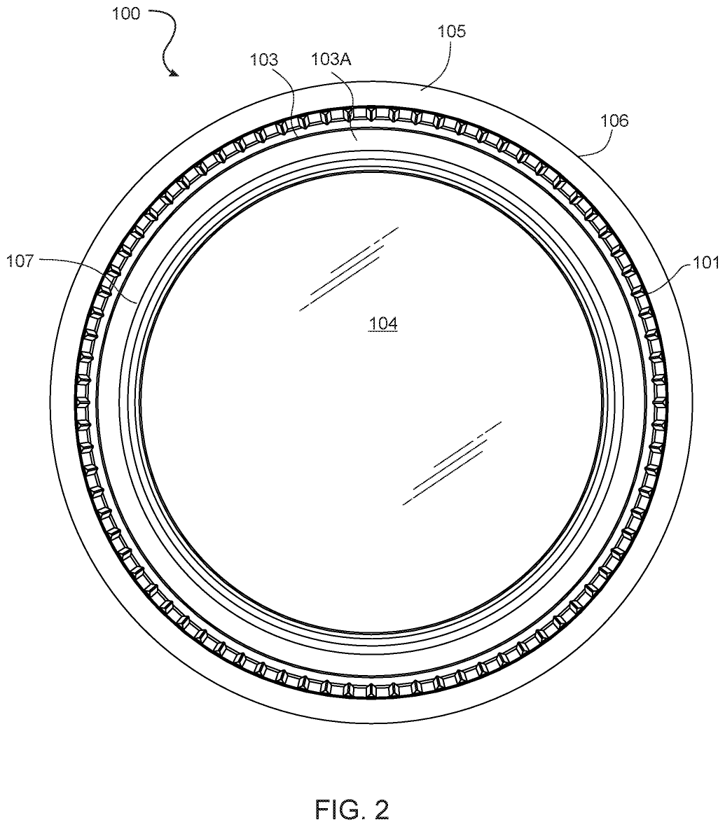

FIGS. 1-2 are various views of a magnetic lens filter system 100 according to an embodiment of the present invention. Referring now to FIGS. 1-2, the magnetic lens filter system 100 comprises an external rotational element 101 having a plurality of ridges 102, wherein the plurality of ridges 102 are equally spaced and extend the entire circumference of the external rotational element 101. In one embodiment, the magnetic lens filter system 100 comprises a primary structural member 103 having a top surface 103A and attachment ring 107. In one embodiment, the top surface 103A is configured to receive indicia, such as brand information and lens filter size. In one embodiment, the attachment ring 107 is threaded and configured to attach to a front portion of a camera adjacent to a camera lens (not illustrated). The threaded connection is typical for traditional lens filters and step-up ring as well known in the art.

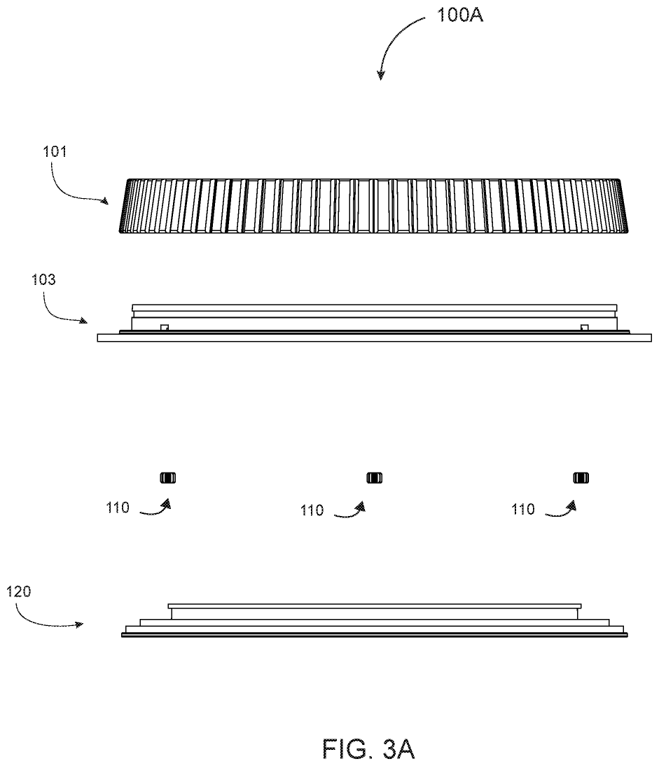

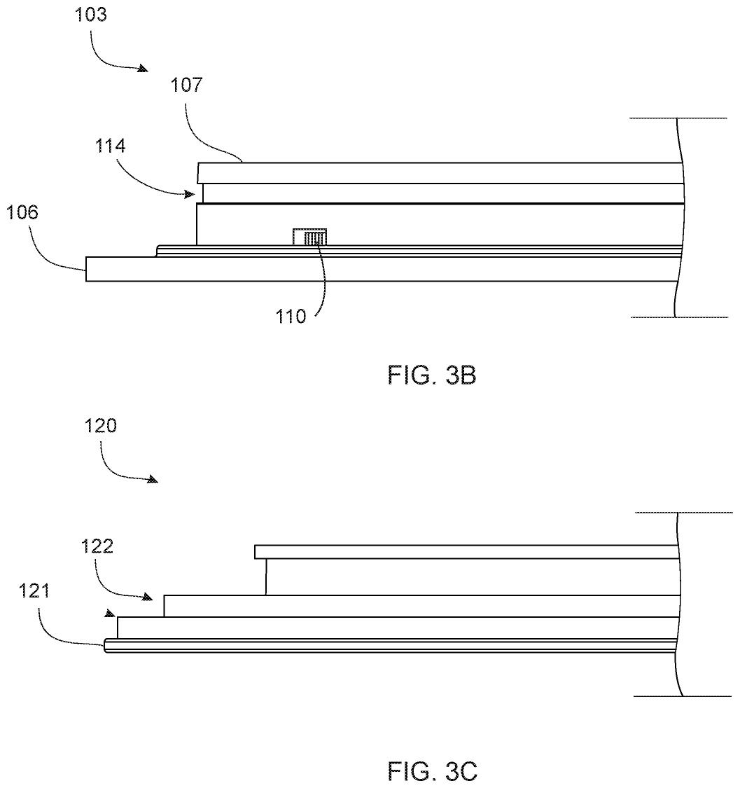

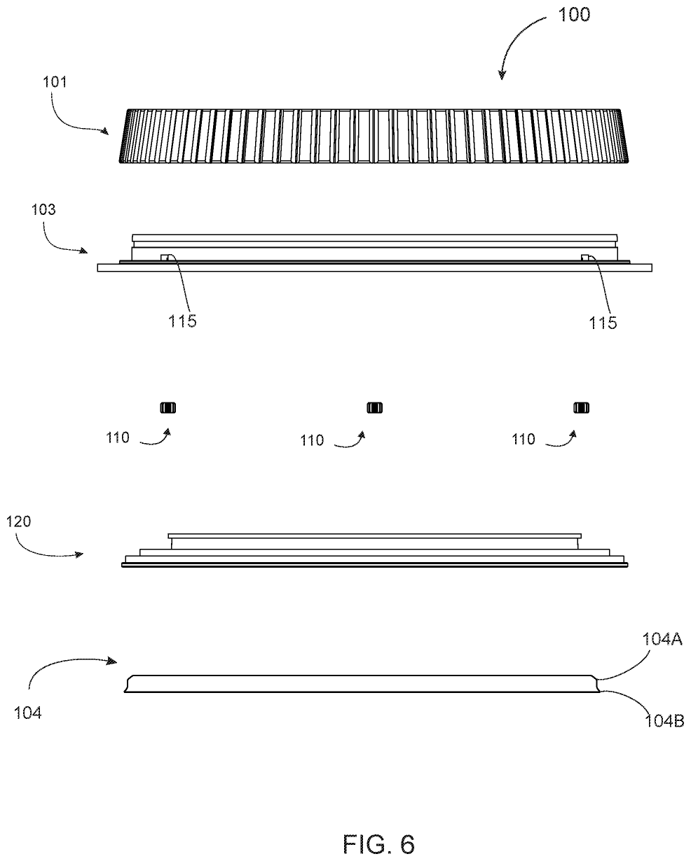

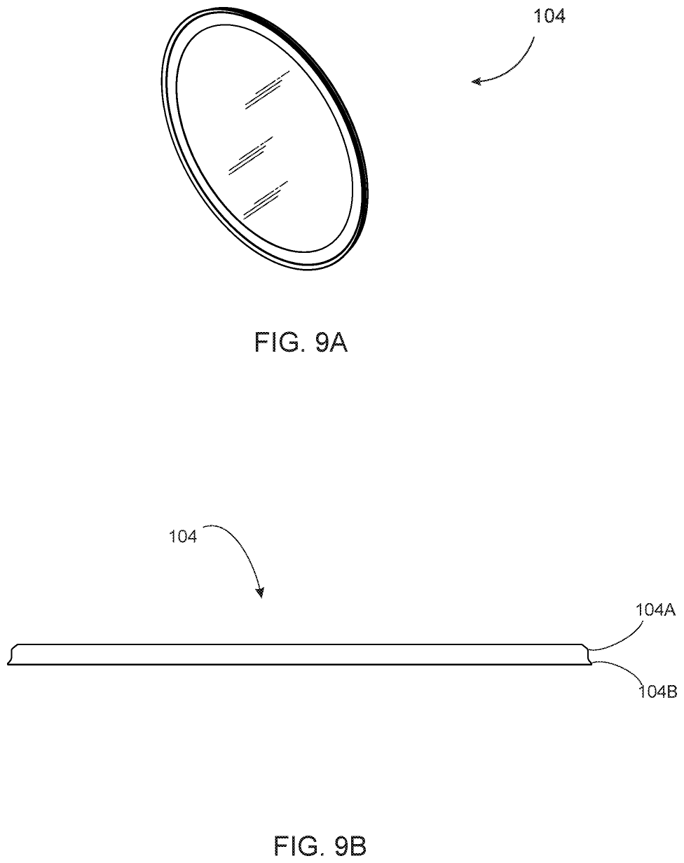

Also visible in FIGS. 1-2 is a magnetic lens filter 104. The lens filter, also called a camera lens filter or photography filter, is configured to modify the images captured with a camera, including enhancing color, reducing reflections, and/or aiding in capturing scenery in extremely difficult lighting conditions as well known in the art. In one embodiment, the magnetic lens filter comprises a magnetic lens holder 104A (best seen in FIGS. 9A-B). The magnetic lens holder 104A is configured to hold the lens filter, and may be provided in a variety of sizes. Likewise, the lens filter itself may be provided in a variety of sizes and types, such as neutral density, polarizing, UV, circular polarizer, linear polarizer, etc. In one embodiment, the magnetic lens holder 104A is configured to magnetically attach to an interface member 120 (best seen in FIG. 3C and FIG. 6). In one embodiment, the interface member 120 is comprised of steel. In other embodiments, other magnetic materials may be provided. For instance, any material that is configured to magnetically attach with a magnet may be used. Yet in alternative embodiments, magnets may be provided or be included in the interface member 120 providing a magnet-magnet connection engagement between the magnetic lens filter 104 and the interface member 120. In one embodiment, the magnetic lens filter 104 is removable and configured to be removed from the magnetic lens filter system 100 via pressure without rotation. More specifically, the magnetic lens filter 104 may be released from the magnetic lens filter system by overcoming the magnetic attraction force between the magnetic lens filter 104 and the interfacing member 120.

FIG. 3A is a side exploded view of the magnetic lens filter system 100 according to an embodiment of the present invention. Referring now to FIG. 3A, the components of the magnetic lens filter system 100 are illustrated, including external rotational element 101, primary structural member 103, the interface member 120, and plurality of gears 110. In one embodiment, the primary structural member 103 is comprised of aluminum. In one embodiment, the external rotational element 101 is configured to rotate the plurality of gears 110, which is configured to rotate any connecting filters. This will be discussed in greater detail below. In one embodiment, the external rotational element is comprised of nylon. In alternative embodiments, the external rotational element may be any non-magnetic metal, such as aluminum.

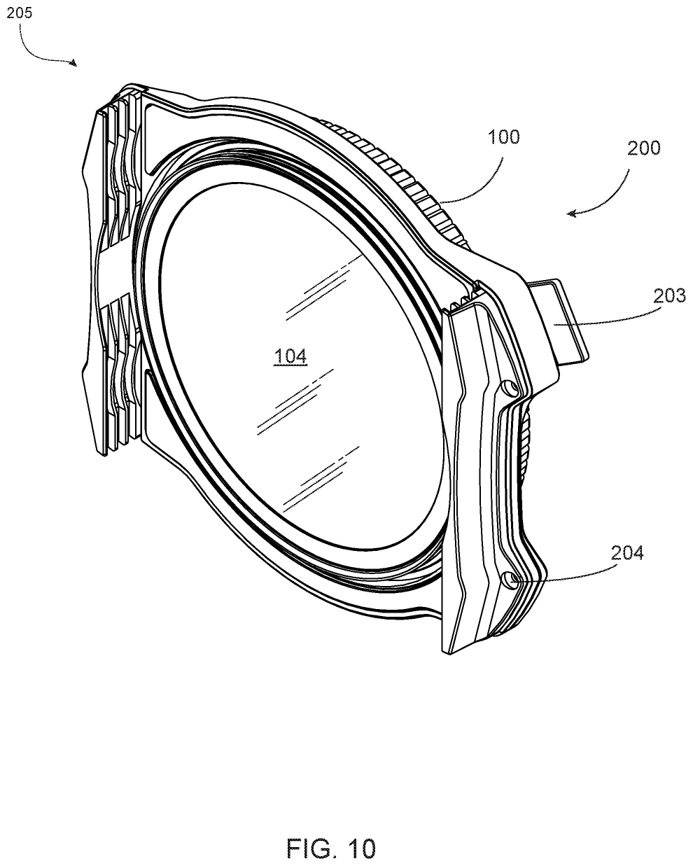

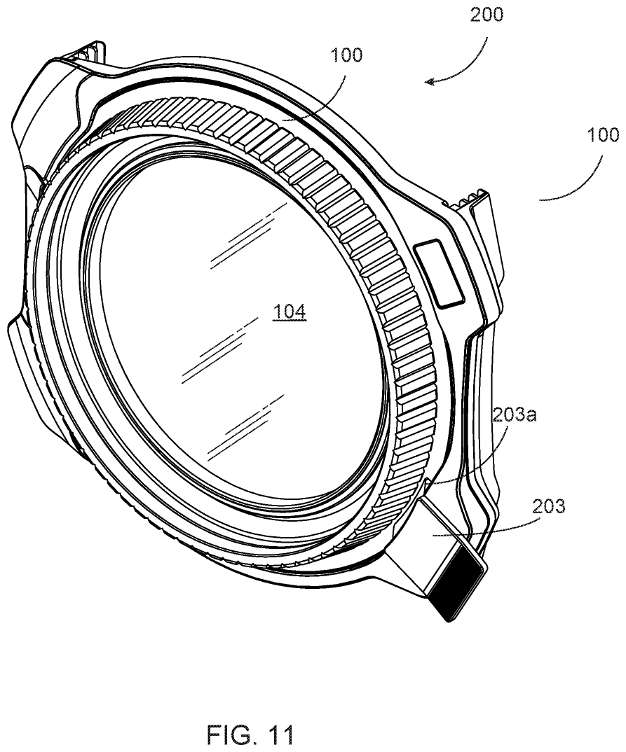

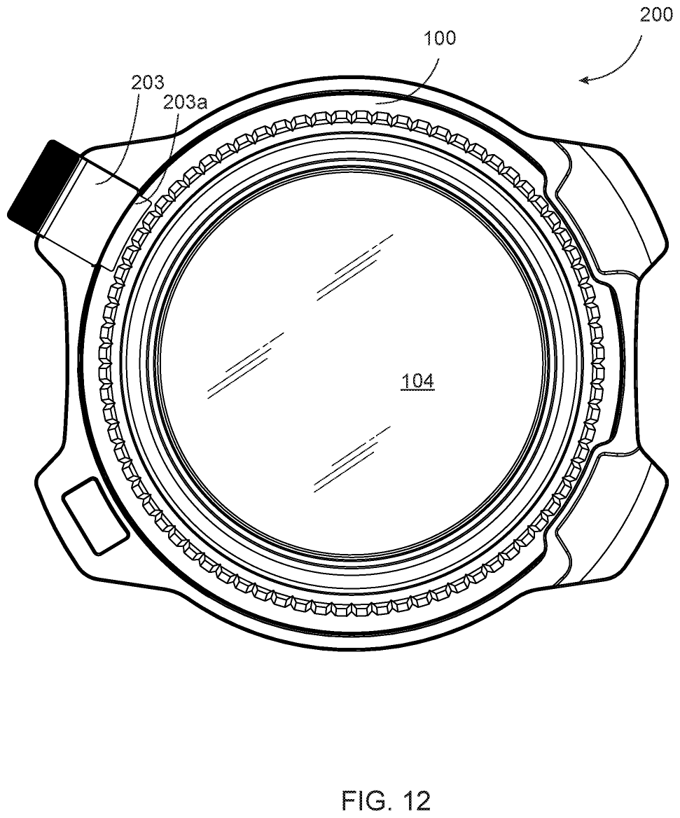

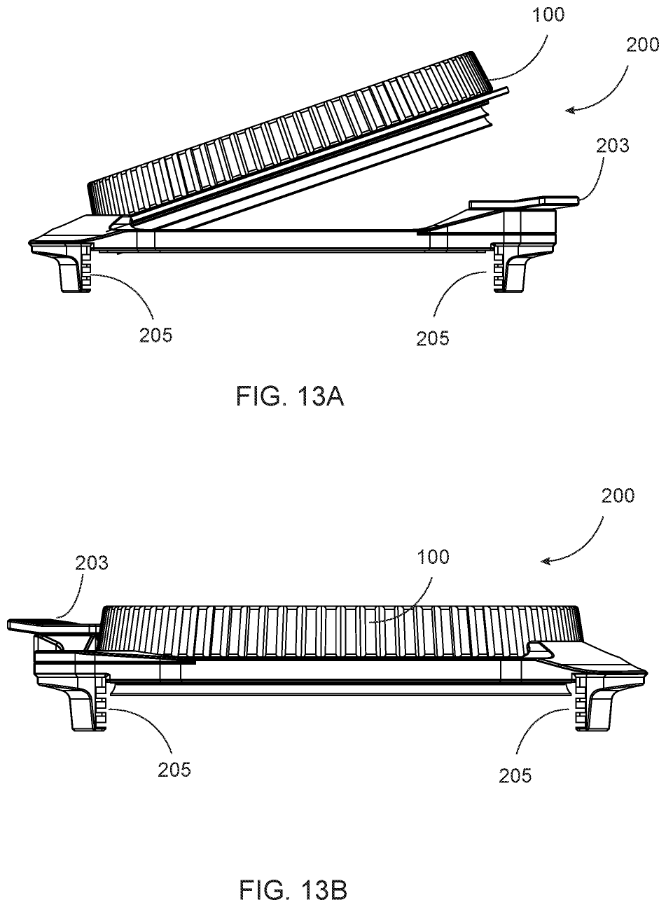

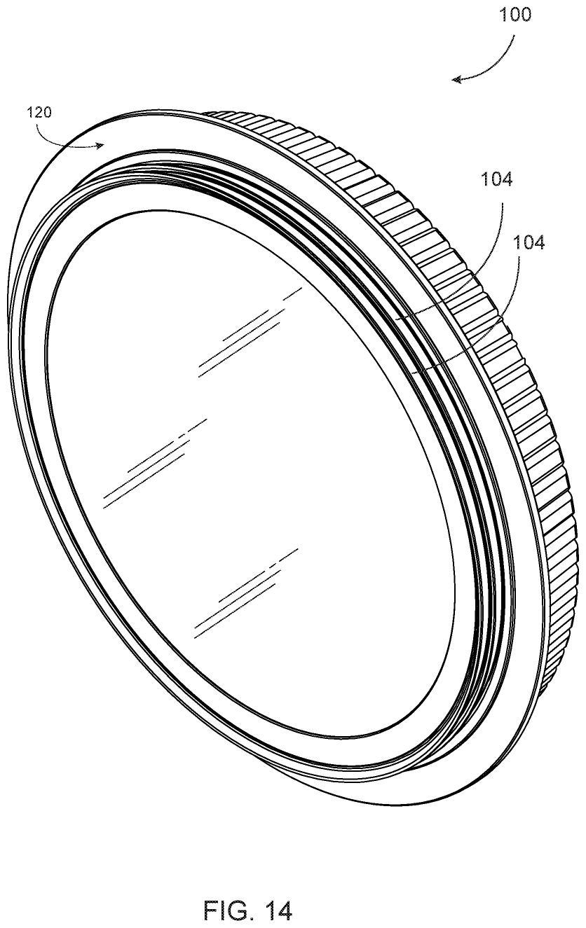

Referring now to FIG. 3B, a detailed side view of the primary structural member 103 is illustrated. As previously mentioned, the primary structural member 103 includes attachment ring 107 configured to connect the magnetic lens filter system 100 to a camera. In one embodiment, the primary structural member 103 includes a flange 106, wherein the flange 106 is used as a connection element for a rectangular filter holder 200 (FIGS. 10-13). This will be described in greater detail below.

In one embodiment, the primary structural member 103 comprises a plurality of gears 110. The gears 110 are a critical aspect of the operation of the system. The gears 110 extend through the primary structural member 103 and translate the rotation from the external rotating element to the interface member 120, which then rotates the magnetic lens filter 104 attached thereto. During operation, when using a magnetic lens filter, rotating the filter during use may provide various filter conditions desired for photography as well known in the art. The gears 110 allow for this rotation easily without the need of a threaded engagement typical of other systems. Further, the combination of the gears 110 and the plurality of ridges 102 allows for precise adjustment without much resistance, while the magnetic lens filter 104 is securely positioned inside the system via the magnetic connection. In one embodiment, the plurality of gears 110 includes inner gears 111, wherein the inner gears 111 are configured to translate the rotation of the external rotational element 101 to the interface member 120. This will be discussed in further detail below.

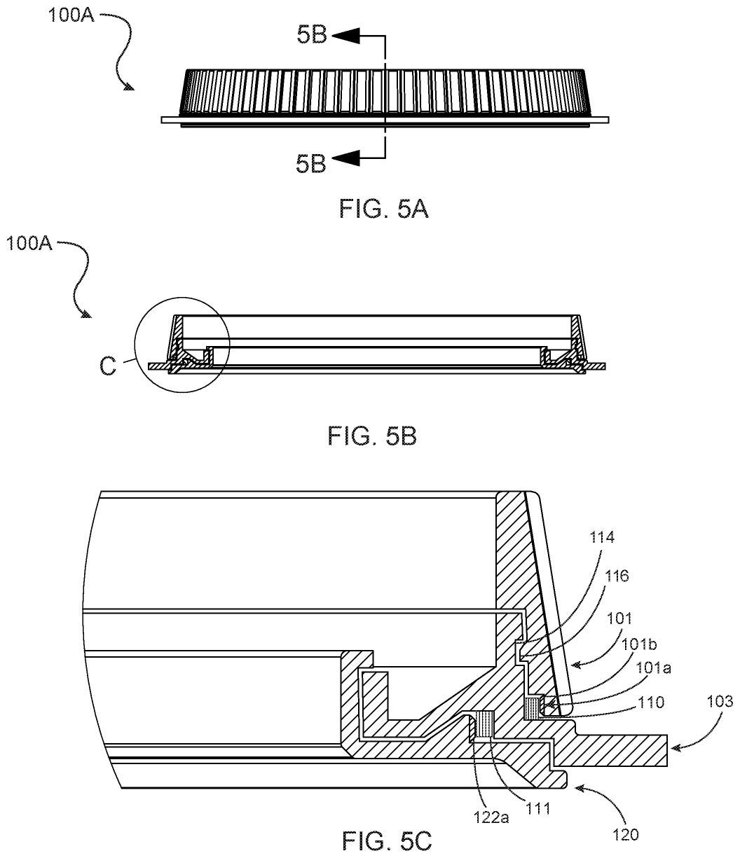

Referring now to FIG. 3C, the interface member 120 is illustrated. In one embodiment, the interface member 120 comprises a magnetic receiving surface 121 and wheel surface 122. In one embodiment, the wheel surface 122 is configured to engage with the inner gears 111 and rotate such that the interface member 120 rotates when the external rotational element 101 is rotated. Best seen in FIG. 5C, in one embodiment, a number of serrations or teeth 122a are provided on wheel surface 122, wherein the serrations or teeth are configured to engage the teeth of the inner gears. Similarly, an inner surface 101a of the external rotational element 101 comprises serrations or teeth 101b configured to engage the teeth of gears 110. In some embodiments, the rotation of the plurality of gears 110 and the external rotational element 101 are both in a first direction and the interface member 120 is consequentially rotated in a second direction that is opposing to the first direction. In one embodiment, the magnetic receiving surface 121 enables one or more magnetic lens filter 104 to magnetically attach to the interface member 120. The magnetic receiving surface 121 contains a magnetic material, such as iron. In one embodiment, the magnetic receiving surface 121 is steel. It should be understood that other magnetic materials may be used. In one embodiment, due to the gear arrangement of the plurality of gears 110, the one or more magnetic lens filter 104 may rotate in the opposite direction of the rotation of the external rotational element 101.

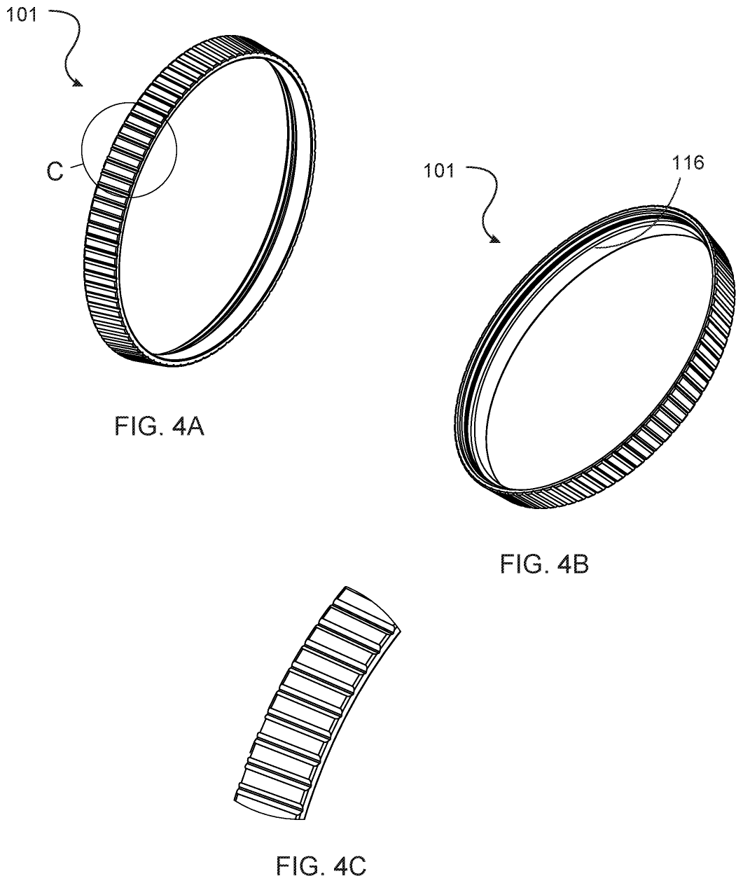

Referring now to FIGS. 4A-C perspective and detailed views of the external rotational element 101 are illustrated. In one embodiment, the external rotational element 101 comprises at least one protrusion 116. This will be discussed in greater detail below.

Referring now to FIGS. 5A-C side views, sectional views, and detailed views of the magnetic lens filter system 100 with the magnetic lens filter 104 removed 100A are illustrated. Referring specifically to FIG. 5C, the engagement between the external rotational element 101 and the primary structural member 103 is shown. Specifically, the external rotational element 101 includes at least one protrusion 116 configured to engage with at least one groove 114 positioned on the primary structural member 103. This configuration aids in the installation of the components.

Referring now to FIG. 6, a side exploded view of the magnetic lens filter system 100 with a magnetic lens filter 104 is illustrated. In this figure, the plurality of gears 110 is exploded from the primary structural member 103, and gear positioning structures 115 are visible on the primary structural member 103. In one embodiment, the plurality of gears 110 is three gears having three gear positioning structures 115 respectively (other gear positioning structures are not visible in this view). Further in this figure, a side view of the magnetic lens filter 104 and magnetic lens holder 104A is shown. In one embodiment, the magnetic lens holder 104A comprises lip 104B.

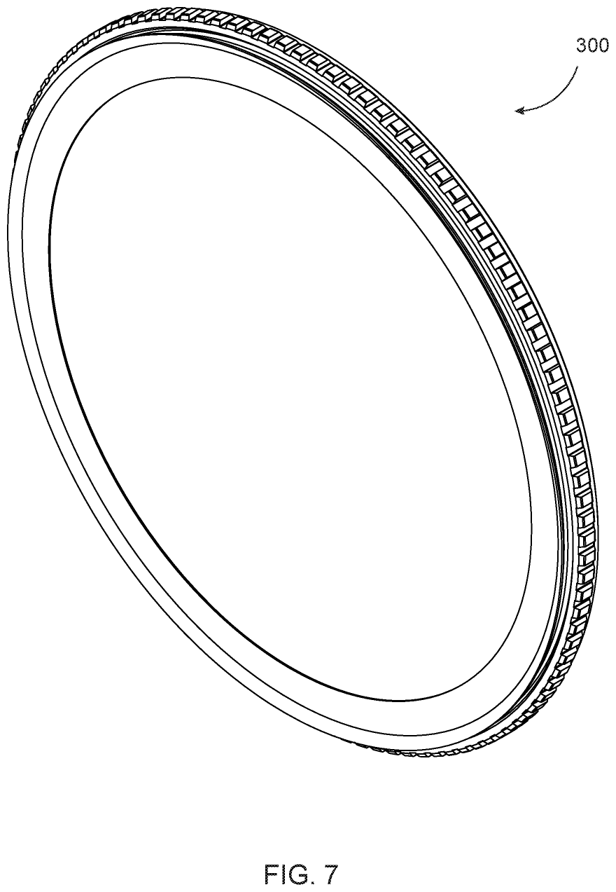

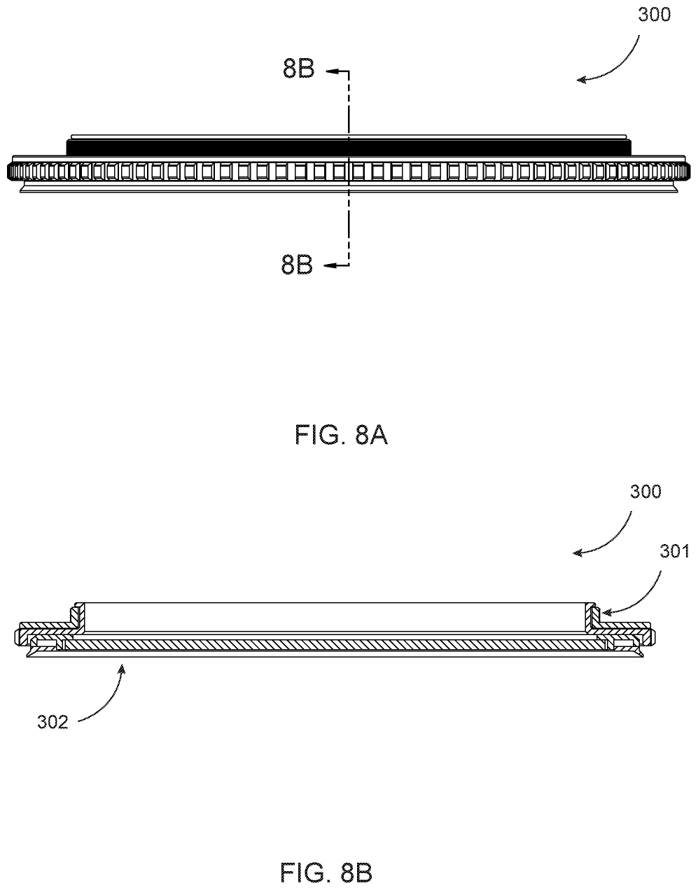

FIGS. 7 and 8A-B illustrate the adapter 300. In one embodiment, the adapter 300 allows for multiple sizes of magnetic lens filters 104 to be used without the need to produce multiple magnetic lens filter systems to accommodate the various sized filters. It should be understood that the use of the adapter 300 is optional. A threaded connection member 301 allows the adapter 300 to be threaded and attached to a front portion of a camera adjacent to a camera lens. A magnetic engagement member 302, similar to the interface member 120 previously discussed, enables the magnetic connection with a magnetic lens filter 104. The adapter 300 enables a magnetic lens filter 104 of a specific size, to be used with various lens diameters. For example, if a user's lens diameter is 77 mm and the magnetic lens filter 104 is 82 mm, a 77 mm to 82 mm adapter allows the 82 mm magnetic lens filter to be used with the 77 mm lens diameter. It should be understood, that this is merely an example, and other adapter size configurations may be provided. In one embodiment, the magnetic engagement member 302 may be a magnetic material, such as steel, or non-magnetic materially containing magnets, or a combination thereof, such as a magnetic material containing magnets for extra securement. In one embodiment, the adapter 300 is configured to rotate similarly as the magnetic lens filter system as previously discussed enabling the simultaneous rotation of an attached magnetic lens filter.

FIGS. 9A-B illustrate perspective and side views of an exemplary embodiment of the magnetic lens filter 104. As previously mentioned, the magnetic lens filter 104 comprises a magnetic lens holder 104A having lip 104B. The magnetic lens holder 104A and lip 104B are configured to engage interface member 120 and/or magnetic engagement member 302. The lip 104B provides a surface enabling easy disengagement of the magnetic lens filter 104 by the user.

FIGS. 10-13 are various views of the magnetic lens filter system 100 with magnetic lens filter 104 attached to a rectangular filter holder 200. Referring now to FIG. 10-12, optionally during use, the rectangular filter holder 200 is configured to hold the magnetic lens filter system 100 while allowing rectangular filters to be added in conjunction with the magnetic lens filter 104. For instance, an exemplary rectangular filter is a graduated neutral density filter (not shown). The graduated neutral filter enables a photographer to use a variable light transmission to capture a desired image, such as darkening a bright sky as well known in the art. A plurality of rectangular filters may be held via rectangular filter holder members 205. The rectangular filter holder 200 further comprises engagement tab 203, and lock mechanism 203a, and mounting holes 204. The lock mechanism 203a, which is controlled via manual engagement applied to the engagement tab 203 by the user, is configured to retain the magnetic lens filter system 100 in the rectangular filter holder 200. More specifically, the lock mechanism 203a is configured to engage the flange 106 of the primary structural member 103. More specifically, a top flange surface 105 is engaged by the lock mechanism 203a. In one embodiment, the engagement occurs automatically, without the need for the user to apply pressure or manual engagement to the engagement tab 203. To release the magnetic lens filter system 100, the user simply applies pressure or manual engagement to the engagement tab 203, and removes the magnetic lens filter system 100 from the rectangular filter holder 200. In one embodiment, the mounting holes 204 enable a user to position the rectangular filter holder members 205 which are configured to grip the one or more rectangular filters (not shown). In some embodiments, the mounting holes are used to secure the magnetic lens filter system 100 and/or the rectangular filter holder members 205 to the camera. In some embodiments, the engagement tab is a rotational engagement member (not shown) wherein the user rotates the engagement tab to mount or remove the magnetic lens filter system 100 from the rectangular filter holder members 205.

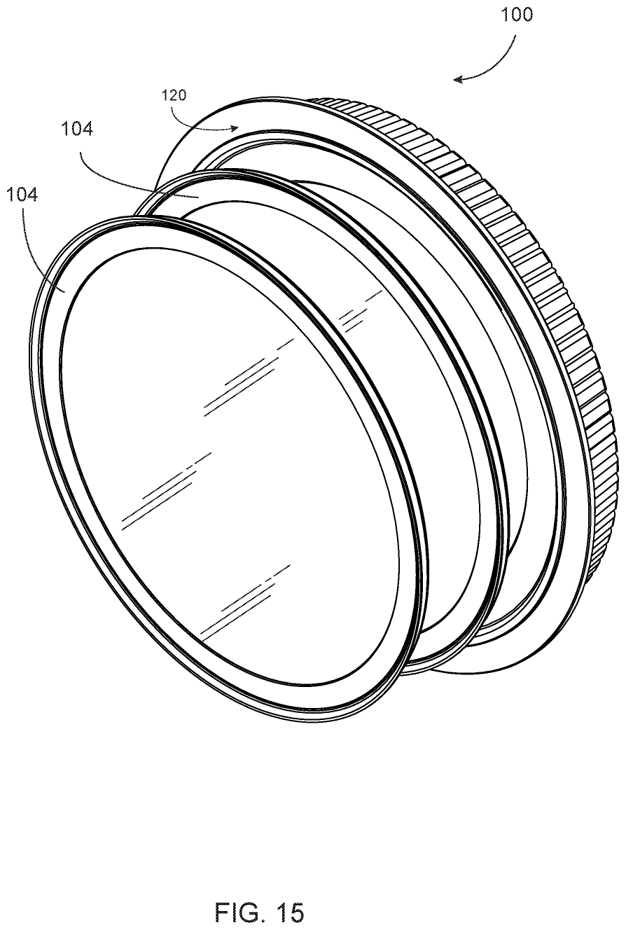

Referring now to FIGS. 14-15, a perspective view and an exploded view of the stackable feature of the present invention are shown respectively. Advantageously, each magnetic lens filter 104 is operable to stack with another magnetic lens filter while reducing the vignetting effect. The stackable feature allows a user to adjust the desired effect, reduce the amount of light entering the filters, etc. as each filter may be rotated and adjusted in relation to each other. Although two stacked filters are shown, it should be understood that more than two magnetic lens filters may be stacked. As previously mentioned, each magnetic lens filter includes a magnetic lens holder 104A. In one embodiment, the magnetic lens holder has a first magnetic surface configured to magnetically attach to the interface member 120. In some embodiments, the magnetic lens holder has a second magnetic surface opposite from the first magnetic surface configured to attach to additional magnetic lens filters to enable stacking. Various methods of material and magnetic positioning to accomplish the aforementioned connections are possible. For instance, in one embodiment, the magnetic lens holder may contain one or more magnets having a pole, e.g. north or south, each facing the first surface and consequently, the interface member when attached. This allows the opposite pole of the one or more magnets facing the second magnetic surface to magnetically attach to an additional magnetic lens filter enabling the stacking position discussed above. More specifically, the second magnetic surface of one magnetic lens filter is attracting to the first magnetic surface of an additional magnetic lens filter.

Although the invention has been described in considerable detail in language specific to structural features, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A magnetic lens filter system comprising:
a primary structural member including an attachment ring;
an external rotational element attached to the primary structural member;
a plurality of gears positioned in a plurality of gear positioning structures provided in the primary structural member, wherein the plurality of gears is in engagement with the external rotational element;
an interface member configured to engage an inner gear in engagement with the plurality of gears such that when the external rotational element is rotated the interface member rotates, wherein the inner rotational element is positioned inside the primary structural member; and,
a removable magnetic lens filter configured to magnetically engage with the interface member such that the removable magnetic lens filter rotates when the external rotational element rotates.

2. The magnetic lens filter system of claim 1, wherein the attachment ring is threaded and configured to attach to a front portion of a camera.

3. The magnetic lens filter system of claim 1, wherein the primary structural member includes a flange, wherein the flange is configured to engage a rectangular filter holder such that the magnetic lens filter system may be used in conjunction with the rectangular filter holder, wherein the rectangular filter holder is configured to hold a plurality rectangular filters.

4. The magnetic lens filter system of claim 1, wherein external rotational element includes a plurality of ridges, wherein the plurality of ridges are equally spaced and extends along an entire circumference of the external rotational element.

5. The magnetic lens filter system of claim 1, wherein the removable magnetic lens filter is configured to be removed from the interface member via manual pressure applied by a user without the need to rotate the removable magnetic lens filter.

6. The magnetic lens filter system of claim 1, wherein the external rotational element includes at least one protrusion configured to engage with at least one groove positioned on the primary structural member.

7. The magnetic lens filter system of claim 1, wherein the removable magnetic lens filter comprises a magnetic lens holder containing a magnetic surface, wherein additional removable magnetic lens filters having additional magnetic surfaces are configured to stack to the removable magnetic lens filter.

8. The magnetic lens filter system of claim 3, wherein the rectangular filter holder comprises an engagement tab and lock mechanism, wherein the lock mechanism is configured to engage the flange of the primary structural member to secure the magnetic lens filter system in the rectangular filter holder.

9. The magnetic lens filter system of claim 8, wherein the lock mechanism is released via pressure of manual engagement applied to the engagement tab by a user.

10. A magnetic lens filter system comprising:
a primary structural member including an attachment ring configured to attach the magnetic lens filter system to a camera lens;
an external rotational element attached to the primary structural member;
an interface member partially positioned inside the primary structural member;
a plurality of gears configured to engage the external rotational element and the interface member such that rotation of the external rotational element is transferred to the interface member; and,
a magnetic lens filter configured to magnetically engage with the interface member such that the removable magnetic lens filter rotates when the external rotational element rotates.
